(19) United States
(12) Patent Application Publication
(10) Pub. No.: US 2005/0196571 A1
(43) Pub. Date: Sep. 8, 2005

(54) Air freshener

(76) Inventors: John H. Penny III, Lusby, MD (US); Catrina L. Penny, Lusby, MD (US)

Correspondence Address: Richard C. Litman;LITMAN LAW OFFICES, LTD., P.O. Box 15035, Arlington, VA, 22215, US

(21) Appl. No.: 10/790,822

(22) Filed: Mar. 3, 2004

(51) Int. Cl. B32B 9/00

(52) U.S. Cl. 428/40.1

(57) ABSTRACT

A decorative, self-adhesive sticker/decal removable from a peel and stick board. In one embodiment, fragrance is integrated into paint that is applied to a vinyl sheet or similar material sheet to complete the decorative aspect of the self-adhesive sticker/decal. The sticker/decal is preferably painted and shaped to depict an item having a pleasant scent and a particular scent incorporated in the paint which is associated with the item. In another embodiment, a foam strip is adhered to the sticker/decal, the foam strip carrying the scent. The scent may be refreshed by spraying the strip. In a third embodiment, a first layer is decorative and a second layer, laminated upon the decorative layer is a clear, removable, and replaceable element emanating the air freshening scent. The clear layer is made of fine plastic mesh with scented gel filling the interstices of the mesh.

### BACKGROUND OF THE INVENTION

1. Field of the Invention

The present invention relates to air fresheners. More particularly, the present invention relates to stickers/decals removable from a peel and stick surface and having an air freshening scent.

2. Description of the Related Art

A variety of air fresheners are known to remove, counteract, or mask undesirable odors. Many of these air fresheners require electrical energy or heat from a flame-heated source. Others are unsightly, take precious space, or are easily damaged. It would be desirable to provide an attractive sticker/decal having air freshening scent which may be mounted on window glass or other surface in a closed space such as a room or automobile. It would further be desirable that such a sticker/decal/decal is made easily packaged and available and easily peeled and applied to a desired surface. It would further be desirable that such a sticker/decal be subject to replenishment of the scent material, once it has dissipated. Another related use would be to provide an unpleasant odor as part of a gag sticker/decal/decal depicting a skunk or other character associated with an unpleasant odor.

U.S. Pat. No. 4,696,844, issued Sep. 29, 1987, to Spector, describes a film-type air freshener having a transparent plastic film having a design screen printed thereon and an adhesive surface on one side wherein the film is impregnated with a fragrance. The fragrance is slowly released from the film into the atmosphere.

U.S. Pat. No. 4,720,409, issued Jan. 19, 1988, to Spector, describes a film-laminate type air freshener having a transparent backing film with a clear adhesive on one side and a face film impregnated with a fragrance. A design is screen printed on the front surface of the backing film.

U.S. Pat. No. 4,824,707, issued Apr. 24, 1989, to Spector, describes a rupturable capsule containing a fragrance embedded between a backing film and a normally opaque facing film. When the capsule is ruptured-, the fragrance soaks into the facing film, making the facing film translucent and exposing art work depicted either on the front side of the backing film or the back side of the facing film.

U.S. Pat. No. 5,163,616, issued Nov. 17, 1992, to Bernarducci, et al., describes an air freshener device having peel-away seals that expose chambers of fragrances.

U.S. Pat. No. 6,162,247, issued Dec. 19, 2000, to Martz, describes a personal perfume application method and system having a sticker patch having an absorbent layer that is sprayed with a perfume. An adhesive side of the patch is placed against the inside surface of a wearer's clothing.

U.S. Pat. No. 4,687,203, issued Aug. 18, 1987, to Spector, describes a scratch-and-sniff game board for children.

U.S. Pat. No. 5,021,275, issued Jun. 4, 1991, to Kim, describes ornamental stickers having a release backing board.

U.S. Patent Publication No. 2003/0017129A1, Published Jan. 23, 2003, for Maleeny et al., describes a scented decorative item having a variety of available fragrance agents.

Internet website http://www.scentsupply.com/noname3.html describes liquid potpourri.

Internet website http.://www.exceptionalteaching.com/index_files/page0027.htm (page 1) describes Peel & Stick WonderFoam.

Internet website http://www.medo.com/pdt_sprays.htm describes automotive air freshener sprays.

Internet website http://www.medo.com/pdt_gels.htm describes air freshener Ultra Gel 2000.

None of the above inventions and patents, taken either singly or in combination, is seen to describe the instant invention as claimed. Thus, an air freshener solving the aforementioned problems is desired.

### SUMMARY OF THE INVENTION

The air freshener of the present invention is a decorative, self-adhesive sticker/decal removable from a peel and stick surface similar to a self-adhesive stamps in their simplest form. The inventive air freshener is described in three embodiments. In the first embodiment, fragrance is integrated into paint that is applied to a vinyl sheet or similar material sheet to complete the decorative aspect of the self-adhesive sticker/decal. The sticker/decal is preferably painted and shaped to depict an item having a pleasant scent and a particular scent incorporated in the paint which is associated with the item. Such a sticker/decal could be cut in the shape of an apple, painted to depict an apple, and scented to match the scent of apples. The air freshener sticker/decal/decal and peel and stick backing is sealed in a package until its use to maintain the scent of the sticker/decal/decal until use.

In another embodiment, an absorbent material such as a foam strip is provided as part of the air freshener item sticker/decal/decal, the foam strip carrying the scent. Upon depletion of the scent material it may be renewed by applying additional scent material to the foam strip.

In a third embodiment, a first layer is decorative and a second layer, laminated upon the decorative layer is a clear, removable, and replaceable element emanating the air freshening scent. Upon depletion of the scent, the clear layer is removed and replaced with a replacement clear layer having a fresh supply of scent material incorporated therein. The clear layer is made of fine plastic mesh with scented gel filling the interstices of the mesh.

It is an aspect of the invention to provide improved elements and arrangements thereof for the purposes described which is inexpensive, dependable and fully effective in accomplishing its intended purposes.

These and other aspects of the present invention will become readily apparent upon further review of the following specification and drawings.

### BRIEF DESCRIPTION OF THE DRAWINGS

FIG. 1A is a plan view of an air freshener according to the present invention.

FIG. 1B is a sectional view of air freshener of FIG. 1A.

FIG. 1C is an environmental view of the inventive air freshener of FIG. 1A.

FIG. 2A is a plan view of another embodiment of the air freshener of the present invention.

FIG. 2B is a sectional view of the air freshener of FIG. 2A.

FIG. 2C is an environmental view of the inventive air freshener of FIG. 2.

FIG. 3A is a plan view of another embodiment of the air freshener of the present invention having a gel-filled replaceable tape segment of transparent plastic mesh.

FIG. 3B is a sectional view of the air freshener of FIG. 3A.

FIG. 3C is an environmental view of the inventive air freshener of FIG. 3A.

Similar reference characters denote corresponding features consistently throughout the attached drawings.

### DETAILED DESCRIPTION OF THE PREFERRED EMBODIMENTS

The present invention is a decorative, self-adhesive sticker/decal/decal removable from a peel and stick surface similar to a self-adhesive postage stamps in their simplest form. In the first embodiment, fragrance is integrated into paint that is applied to a vinyl sheet or similar material sheet to complete the decorative aspect of the self-adhesive sticker/decal.

In another embodiment, an absorbent material such as a foam strip is provided as part of the air freshener item sticker/decal, the foam strip carrying the scent. Upon depletion of the scent material it may be renewed by applying additional scent material to the foam strip.

In a third embodiment, a first layer is decorative and a second layer, laminated upon the decorative layer is a clear, removable, and replaceable element emanating the air freshening scent. Upon depletion of the scent, the clear layer is removed and replaced with a replacement clear layer having a fresh supply of scent material incorporated therein.

It is to be understood that the present invention is not limited to the embodiments described above, but encompasses any and-all embodiments within the scope of the following claims.

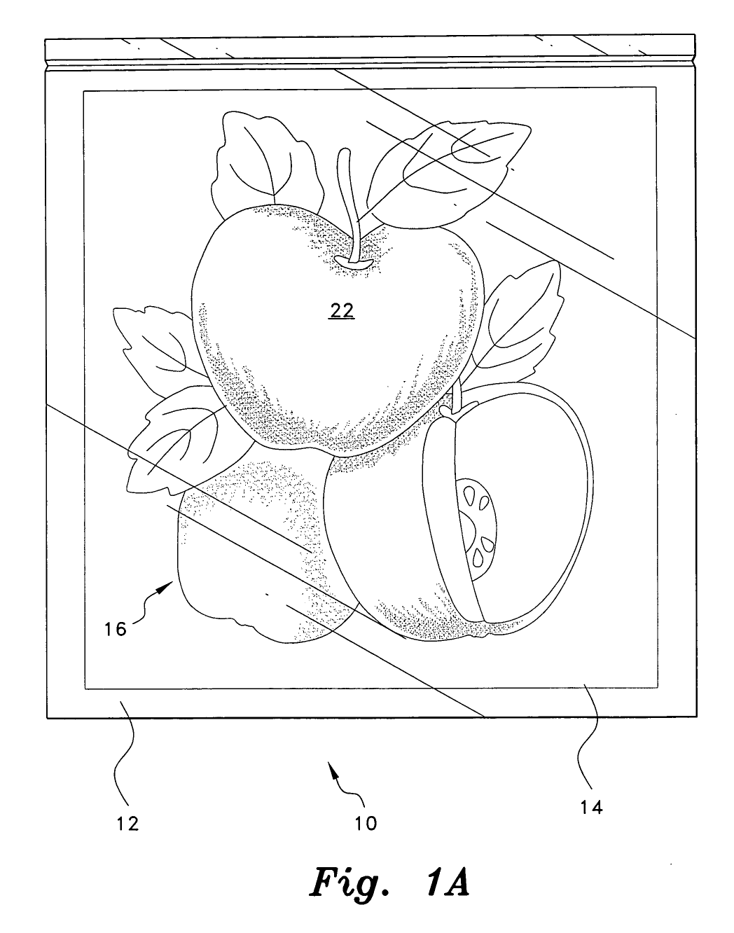

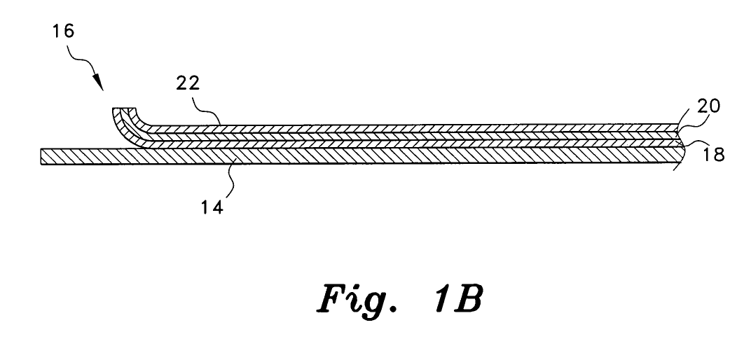

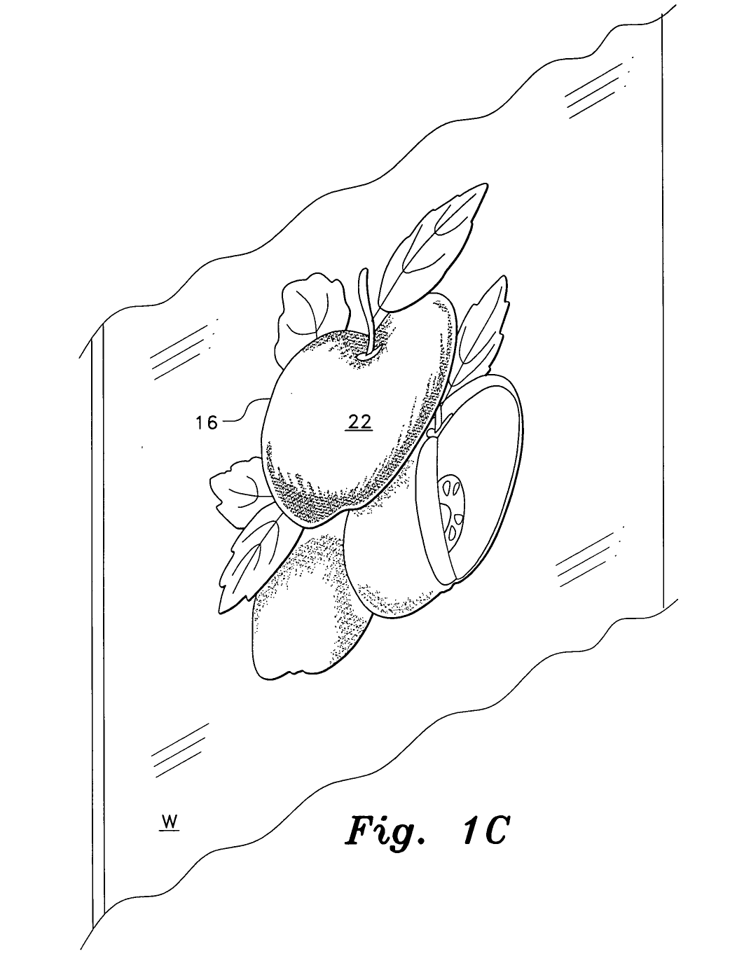

Referring to FIGS. 1A-1C air freshener sticker/decal system 10 includes a transparent sealed bag 12 within which is stored scented sticker/decal 16 mounted on release backing board 14 and having a scented paint thereon, the stored sticker/decal 16 being sealed within bag 12 to maintain the air freshening scent during storage and distribution until used. As illustrated, the sticker/decal 16 has an apple motif, the paint 22 of which contains and releases a scent having an aroma associated with apples. The package 12 is preferably of a minimum size relative to the release backing board 14 to maintain equilibrium of scent material within the package with minimum loss of scent from the sticker/decal. As shown in sectional view 1B (partially pulled away), backing board 14 has sticker/decal 16 having a primary adhesive layer 18, a plastic sheet 20, such as vinyl sheet, and a scented paint layer 22 (layers are illustrative and not drawn to scale). In FIG. 1C, air freshener sticker/decal 16 is shown mounted on a window W by primary adhesive layer 18 after peeling from release backing board 14.

The release backing board 14 is well known as described as a paper-like material, coated with a film of Teflon or silicone in U.S. Pat. No. 5,021,275, issued Jun. 4, 1991, to Kim, the disclosure of which is hereby incorporated by reference. An example of a scented material useful for mixing in the paint and applied to the peel and stick sticker/decal surface is made by MEDO and known as Ultra Gel 2000, available from MEDO Industries Inc., Baltimore, Md. This scent material may be mixed with any appropriate paint or ink. The air freshener fragrance may be integrated into the paint may be a mixture of liquid potpourri and a spray-on adhesive. The liquid potpourri is available from Scent_Supply, TOMS RIVER, N.J.

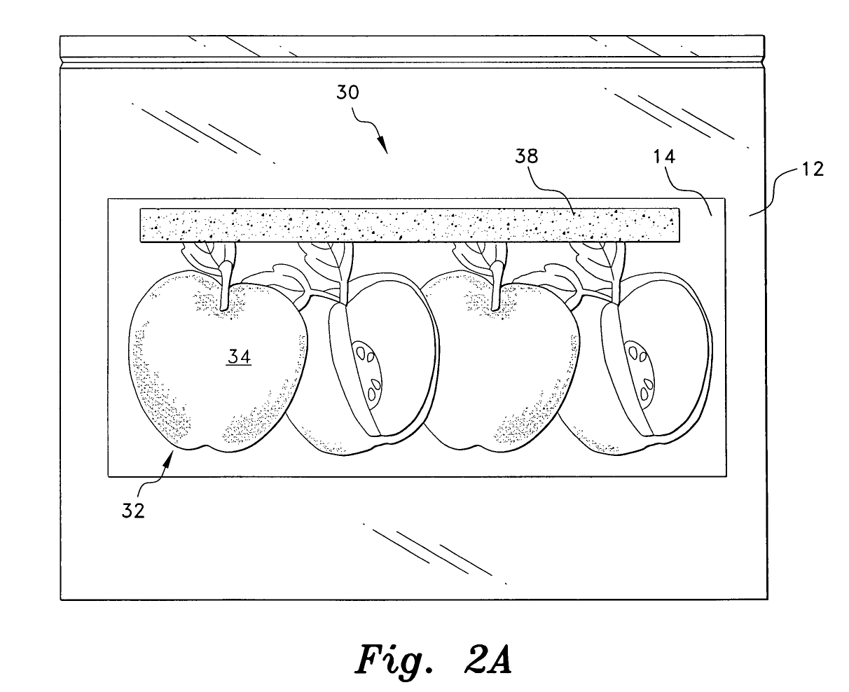

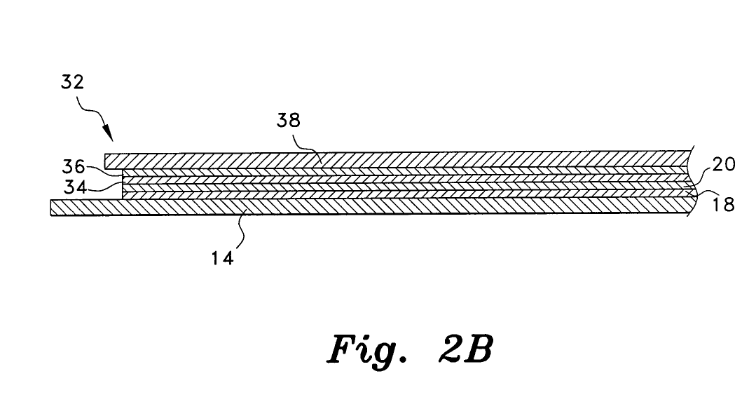

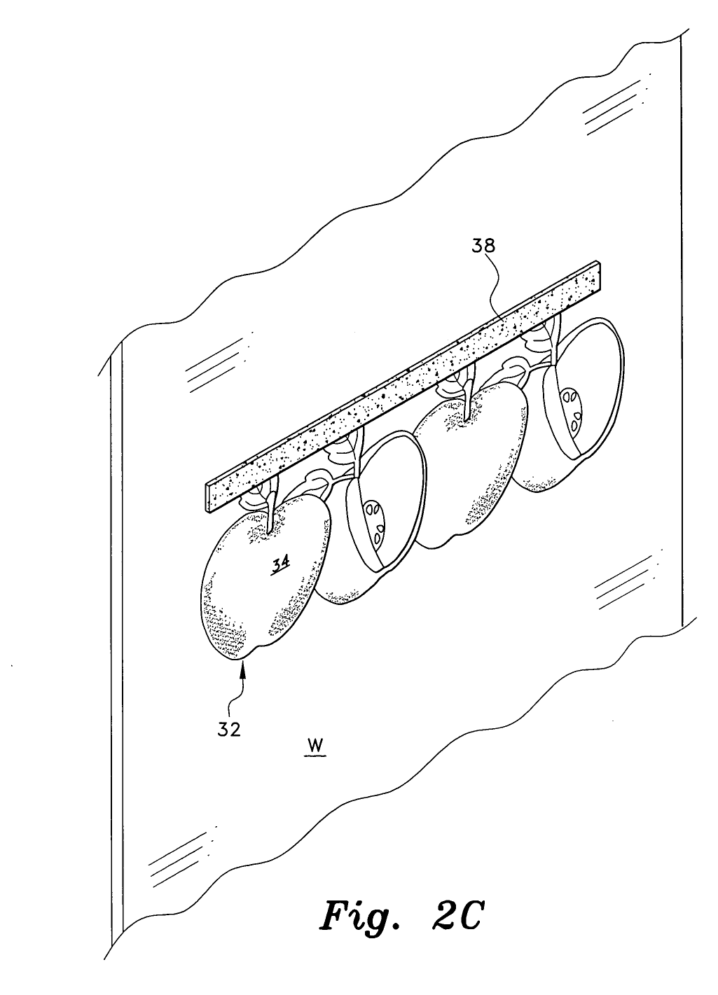

Referring to FIGS. 2A-2C, another embodiment of the air freshener sticker/decal system of the present invention is shown, having a reference number 30 and located on release backing board 14, wherein sticker/decal 32 has a non-scented paint 34 and the decal 32 having an absorbent strip 38, such as foam material, to which a scent material is applied to form the air freshener sticker/decal 32 by any well known manner such as by spraying or placing drops of liquid scent material on the absorbent strip 38 for absorption therein. Once the scent material is dissipated, the air freshener 32 may be rejuvenated by applying additional scent material to absorbent strip 38, thus regaining its effectiveness as an air freshener. The air freshener system 30 may also be provided in a package 12 (see FIG. 1A) and the absorbent strip 38 supplied with an initial amount of scent material absorbed therein.

As shown in sectional view 2B, sticker/decal 32 has a primary adhesive layer 18 attached to release backing board 14, adhesive layer 18 being applied to sticker/decal plastic sheet 20 having non-scented paint layer 34 applied thereon. Absorbent strip 38 is held to paint layer 34 by adhesive layer 36. In FIG. 2C, air freshener sticker/decal 32 is shown mounted on a window W by primary adhesive layer 18 after peeling from release backing board 14. The absorbent strip material may be a clear piece of Peel and Stick WonderFoam available from Exceptional Teaching Aids, Inc., Castro Valley, Calif. The scented material may be a spray-on scented material available from MEDO Industries, Inc., Baltimore, Md. A thin piece of polyester soaked in a liquid potpourri may also be used, the liquid potpourri being re-applied as the scent dissipates.

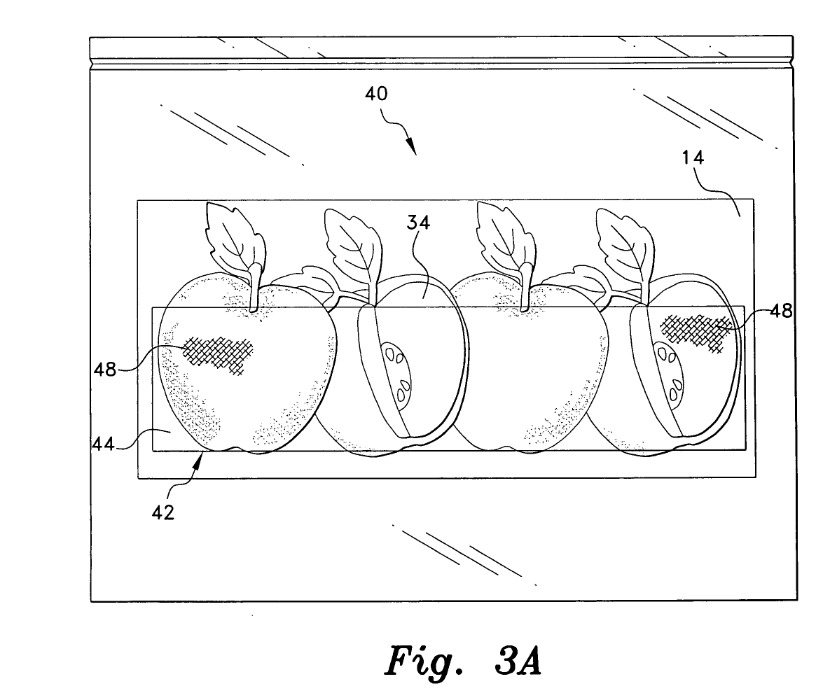

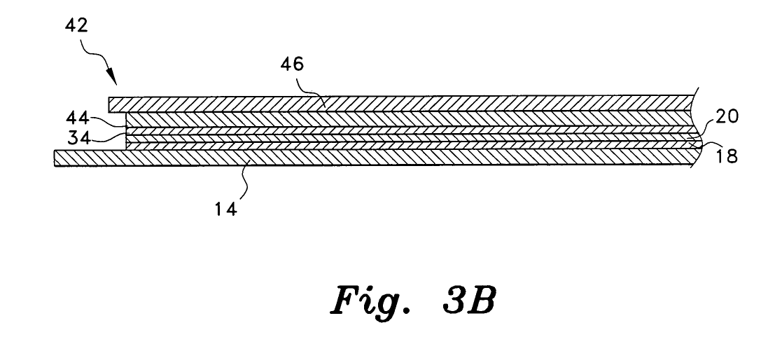

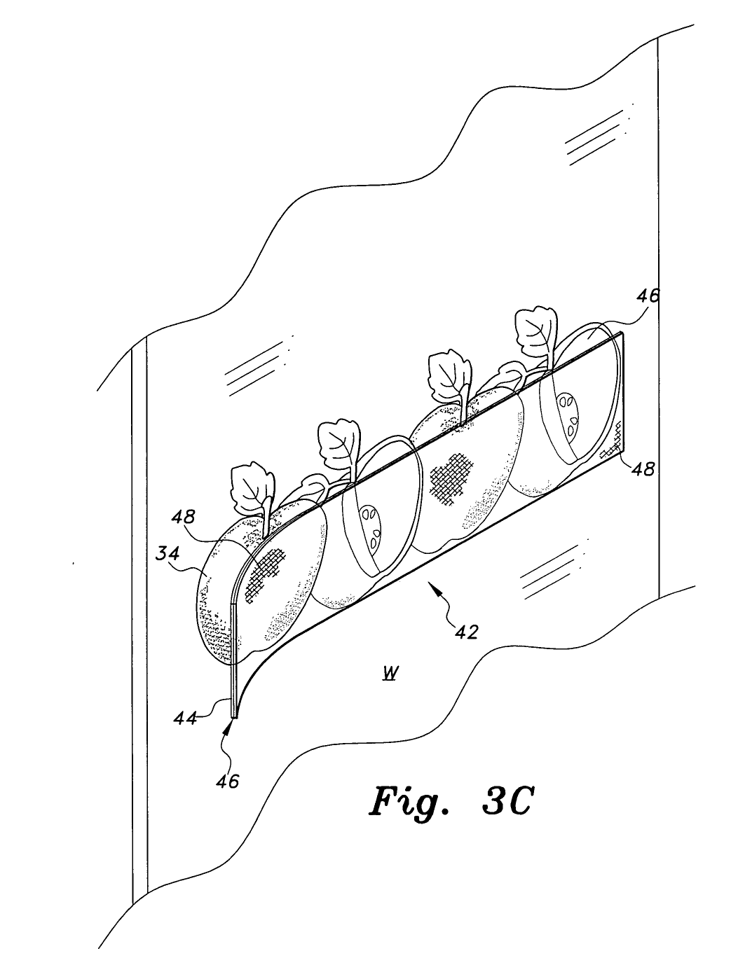

Referring to FIGS. 3A-3C, another embodiment of the air freshener sticker/decal system of the present invention is shown, having a reference number 40, and located on release backing board 14. Sticker/decal 42 has a non-scented paint 34 and features a transparent, air freshening scented tape segment 46 extending over the painted surface of sticker/decal 42. Air freshening scented tape segment 46 has an adhesive layer 44 peelable from paint layer 34 and a scented mesh layer 48 made of clear plastic mesh and having an air freshening scented gel filling the interstices of the mesh. The sticker/decal 42 having the transparent scented tape segment 46 may be initially provided in a package 12 (see FIG. 2A) or the user may be provided with the sticker/decal and a supply of tape 46 for placing over the sticker/decal to form the air freshener 42. Once the scent of the gel in tape segment 46 has dissipated, it may be peeled away and replaced with a fresh tape segment, thus rejuvenating the air freshener sticker/decal for use.

As shown in FIG. 3B, there is shown a sectional view of the air freshener sticker/decal 42 of FIG. 3A. Air freshener sticker/decal 42 is releasably applied to release backing board 14 by primary adhesive 18, adhesive layer 18 being applied to sticker/decal plastic sheet 20 having non-scented paint layer 34 applied thereon. Transparent scented tape 46 is removably applied to paint layer 20 by tape adhesive layer 44. In FIG. 3C, air freshener sticker/decal 42 is shown mounted on a window W by primary adhesive layer 18 after peeling from release backing board 14. The scented tape 46 includes a transparent layer of plastic mesh having a scented gel in its interstices. Although shown as a tape segment, the gel-containing mesh layer may be of any shape and may be so shaped as to conform to the shape of the painted sticker/decal.

The sticker/decal plastic sheet 20 may be a decorative peel and stick, such as that described in U.S. Pat. No. 5,021,275, cited above. The replaceable tape material has an outer layer of transparent plastic mesh material and the MEDO Ultra Gel 2000 as described above is integrated into the peel and stick material by filling the interstices with the scented gel. The tape material has an adhesive layer for removable attachment to the paint layer of the sticker/decal. An alternative transparent plastic layer (not shown) could be a perforated plastic transparent layer having the scented gel disposed in the perforations. Once the scent is spent or dissipated, the second layer or tape is peeled away and replaced with a fresh piece of scented peel and stick material having the MEDO Ultra Gel 2000 incorporated therein.

It is to be understood that the present invention is not limited to the embodiments described above, but encompasses any and all embodiments within the scope of the following claims.

1. A sticker/decal air freshener, comprising:
a sticker/decal having a plastic sheet having a primary adhesive layer; and
a release backing board;
said sticker/decal having a scented material which dissipates into the surrounding air and freshens the air.

2. The sticker/decal air freshener system of claim 1, said sticker/decal having a paint layer on said plastic sheet such that that sticker/decal depicts a decorative item.

3. The sticker/decal air freshener system of claim 2, wherein the scent of said scented material matches the depicted decorative item.

4. The sticker/decal air freshener system of claim 2, wherein said paint layer contains a scented material acting as an air freshener.

5. The sticker/decal air freshener system of claim 4, wherein said the paint in said paint layer contains a scented gel.

6. The sticker/decal air freshener system of claim 4, wherein the paint in said paint layer contains liquid potpourri.

7. The sticker/decal/decal air freshener system of claim 4, said air freshener system including a tear-away or otherwise sealed bag so as to prevent the dissipation of the scent during storage.

8. The sticker/decal air freshener system of claim 2, further comprising a scented foam material adhered to at least a portion of said paint layer of said sticker/decal, said foam material having a refreshable scent material absorbed therein.

9. The sticker/decal air freshener of claim 8, wherein said scented foam material, upon scent dissipation, is refreshed with a spray scent material.

10. The sticker/decal air freshener system of claim 8, said air freshener system including a tear-away or otherwise sealed bag so as to prevent the dissipation of the scent during storage.

11. The sticker/decal air freshener system of claim 2, further comprising a scented tape segment having an adhesive layer removably attached to said paint layer.

12. The sticker/decal air freshener system of claim 11, said scented tape segment having a plastic mesh outer layer having scented gel within the interstices of the plastic mesh layer.

13. The sticker/decal air freshener system of claim 12, said scented tape segment, upon dissipation of the scent thereon, being removable and replaceable with a fresh scented tape segment.

14. The sticker/decal air freshener system of claim 13, said scented tape segment being shaped to conform with said sticker/decal.

15. A method of making a sticker/decal air freshener system comprising the steps of:
placing at least one sticker/decal on a release board;
painting said sticker/decal with a decorative design;
removably adhering a foam strip to said painted sticker/decal; and
spraying said foam strip with an air freshening liquid spray material.

16. The method of making a sticker/decal air freshener system of claim 15, further comprising the step of sealing said scent sprayed sticker/decal as mounted on said release board in a tear-away or other bag or wrapper.

17. The method of making a sticker/decal air freshener system of claim 15, further comprising the step of providing a spray scent material for refreshing said scented foam strip upon the dissipation of said scent material on said foam strip.

18. A method of making a sticker/decal air freshener system comprising the steps of:
placing at least one sticker/decal on a release board;
painting said sticker/decal with a decorative design;
placing a transparent, removably adhering, replaceable scented tape segment on the painted surface of said sticker/decal.

19. The method of claim 18, wherein said replaceable scented tape segment includes a layer of transparent plastic mesh material having a scented gel located in its interstices.

20. The method of claim 19, wherein said tape segment is removed and replaced upon dissipation of the scent of said scented gel.
